(19) United States
(12) Patent Application Publication
(10) Pub. No.: US 2003/0007207 A1
(43) Pub. Date: Jan. 9, 2003

(54) Optical signal transmitter

(76) Inventors: Peter Healey, Ipswich (GB); Paul David Townsend, Woodbridge (GB); David William Smith, Nr. Woodbridge (GB)

Correspondence Address: CORNING INCORPORATED, SP-TI-3-1, CORNING, NY, 14831

(21) Appl. No.: 10/126,044

(22) Filed: Apr. 18, 2002

(30) Foreign Application Priority Data
Apr. 21, 2001 (GB) 0109890.4
Oct. 2, 2001 (GB) 0123603.3

(51) Int. Cl. H04J 14/02; H04B 10/04

(52) U.S. Cl. 359/124; 359/180

(57) ABSTRACT

An optical signal transmitter has an optical source for generating broad-band optical radiation, a wavelength division multiplexer optically linked to the optical source and operable to receive and slice spectrally the broad-band optical radiation, and at least one optical signal generator optically linked to the wavelength division multiplexer to receive a spectral slice of the broad-band optical radiation.

The optical signal generator comprises a travelling wave semiconductor optical amplifier, whereby the spectral slice of the broad-band optical radiation received by the semiconductor optical amplifier determines the wavelength of the signal generated by the semiconductor optical amplifier.

### RELATED APPLICATIONS

This Application claims the benefit of United Kingdom Patent Application No. 0109890.4, filed on Apr. 21, 2001, and United Kingdom Patent Application No. 0123603.3, filed on Oct. 2, 2001, in the names of Peter Healey, Paul D. Townsend and David W. Smith, the entire contents of which is incorporated herein by reference.

### BACKGROUND OF THE INVENTION

1. Field of the Invention

This invention relates to an optical signal transmitter, and in particular to an optical signal transmitter suitable for use in a wavelength division multiplexed system.

2. Description of the Related Art

Wavelength division multiplexing (WDM) is a very attractive solution for increasing the transmission capacity of optical fiber transmission systems. However, it can be relatively expensive to implement due to the cost of selecting, matching and controlling the source wavelengths in order to maintain alignment to predetermined wavelength channels. A well-known technique which has the potential to significantly reduce the cost of WDM systems is spectral slicing, in which a broad-band light source, such as a light-emitting diode (LED) or amplified spontaneous emission (ASE) of an erbium-doped fiber amplifier, is separated into constituent wavelength channels or spectral slices using, for example, a wavelength division multiplexer such as an arrayed waveguide grating. The LED can be fabricated at a low cost and modulated directly. However, its output power is insufficient to accommodate many channels by spectral slicing. The spectrally sliced ASE light source can provide much higher output power compared with the LED. Unfortunately, it requires an expensive external modulator. In early arrangements, a number of identical LEDs were directly modulated and their outputs combined in a grating multiplexer which selected a different spectral slice of each of the LEDs outputs in order to create the WDM. However, it is now more common to see a single high power ASE light source, whose output is then split into a number of specific wavelength channels by a wavelength division multiplexer. These slices are then individually modulated before being re-combined for transmission.

Problems associated with spectral slicing include power budget limitations, particularly if LEDs and single mode fiber are used, excess intensity noise due to the use of incoherent sources, and inter-symbol-interference due to fiber dispersion. Excess intensity noise can be reduced by employing broader bandwidth slices, but this increases fiber dispersion and inter-symbol-interference. Super continuum sources can also be used to generate broad-band optical radiation with reduced excess intensity noise, though implementation using a super continuum source is more complicated. Inter-symbol-interference can be reduced by employing low dispersion fiber.

A WDM passive optical network architecture for upstream transmission has been proposed (‘A Low-Cost WDM Source with an ASE Injected Fabry-Perot Semiconductor Laser’, IEEE Photonics Technology Letters, Vol. 12, No. 8, August 2000) which uses a Fabry-Perot semiconductor laser diode (F-P SLD) as a WDM source. Broad-band ASE is transmitted to a remote node, where it is spectrally sliced by an arrayed waveguide grating. The spectrally sliced ASE is then injected into the F-P SLD, which locks the wavelength of upstream data to the injected ASE wavelength. An F-P SLD normally displays a multi-mode output in which the power of a particular mode fluctuates randomly with time. Single-mode oscillation may be achieved by injecting a narrow band signal. However, in this case, a mode or modes that is/are nearest to the peak wavelength of the injected ASE is/are locked to the injected light and other modes suppressed. Spectrally sliced ASE displays random amplitude and random phase, and the narrower the bandwidth of the spectral slice used, the lower the optical power of the slice and the lower the signal to noise ratio. Thus, the inherent narrow band selectivity of the Fabry-Perot laser modes will act to reduce the signal to noise ratio of the injected light. This will, in turn, lead to excess noise on the laser output. As the spectral slice used to injection lock the laser will be broader than the bandwidth of the individual Fabry-Perot laser modes, the usual conditions for stable operation will not be satisfied and unstable operation is very likely. The situation will be made worse if more than one mode is excited by the injected ASE, leading to severe noise and instability. Careful matching of the wavelength of the ASE slice to the wavelength of the desired mode of oscillation of the F-P SLD is therefore required to minimise unstable oscillation. Furthermore, the modes of oscillation of F-P SLDs vary from device to device and are dependent on temperature and bias current. A stable environment is therefore required to ensure stable operation, and whilst this can be achieved under laboratory conditions, it is very difficult to maintain matched wavelengths in a network, particularly when the components might be many kilometres apart in different environments. Although it may be possible to provide an active control system to maintain temperature and bias current within tolerances for stable operation, such a system is likely to be expensive and complex.

It is an object to provide an improved optical signal transmitter.

### BRIEF SUMMARY OF THE INVENTION

According to a first aspect of the invention, there is provided an optical signal transmitter comprising:

(i) an optical source for generating broad-band optical radiation;

(ii) a wavelength division multiplexer optically linked to the optical source and operable to receive and slice spectrally the broad-band optical radiation; and

(iii) at least one optical signal generator optically linked to the wavelength division multiplexer to receive a spectral slice of the broad-band optical radiation;

wherein the optical signal generator comprises a travelling wave semiconductor optical amplifier, whereby the spectral slice of the broad-band optical radiation received by the semiconductor optical amplifier determines the wavelength of the signal generated by the semiconductor optical amplifier.

Unlike an F-P SLD, a travelling wave semiconductor optical amplifier does not comprise a resonant cavity, and so does not naturally display a multi-mode output, but will amplify whatever signal is fed into it. Hence, its output will remain matched to the wavelength division multiplexer. It is therefore only necessary to ensure that the spectral slice falls within the gain bandwidth of the amplifier, which is typically 40-50 nm wide.

It is preferable to operate the travelling wave semiconductor optical amplifier(s) in the gain saturated regime since in addition to amplifying and modulating the incident spectral slice, this will have the effect of squeezing the amplitude fluctuations, so reducing the excess intensity noise and increasing the noise margin of the system. This enables narrower spectral slices to be employed, so increasing the allowable WDM channel density (channels per unit wavelength) and reducing the effect of fiber dispersion.

Suitably, the wavelength division multiplexer comprises an arrayed waveguide grating, a thin film filter, a directional coupler or a blazed grating type filter.

Preferably, the optical source comprises an erbium-doped fiber amplifier.

Alternatively, the optical source may comprise a semiconductor optical amplifier, a superluminescent diode, a super continuum source or an LED.

Preferably, the transmitter further comprises a bandpass filter to limit the spectrum of the broad-band optical radiation. The use of a filter ensures that the arrayed waveguide grating is only excited by light covering one free-spectral-range and hence guarantees that there is only one wavelength per channel.

Preferably, the travelling wave semiconductor optical amplifier is a reflection-mode semiconductor optical amplifier, and the transmitter further comprises an optical circulator or directional coupler to separate the signal generated by the semiconductor optical amplifier from the broad-band optical radiation. The front facet of a reflection mode semiconductor optical amplifier is designed to have a very low reflectivity of around 10⁻⁵ or lower, and a rear facet reflectivity of around 30% or higher. Reflection mode semiconductor optical amplifiers provide very high gain because the radiation is amplified twice, once in each direction. High gain ensures that saturation effects become noticeable at quite low input powers (even below 10 μW). This has the added benefit of minimising the broad-band source power required to seed the transmitter well into the saturation regime in order to minimise excess intensity noise. Furthermore, when used in conjunction with at least two optical signal generators for receiving respective spectral slices of the broad-band optical radiation, a reflection mode amplifier enables a single wavelength division multiplexer to perform the dual function of spectrally slicing the broad-band radiation and multiplexing the signals generated by the signal generators.

According to a second aspect of the invention, there is provided a wavelength division multiplexing source comprising an optical transmitter as above incorporating at least two optical signal generators for receiving respective spectral slices of the broad-band optical radiation.

According to a third aspect of the invention, there is provided a network comprising a wavelength division multiplexing source as above, wherein the optical signal generators are located at a plurality of locations in the network and the wavelength division multiplexer is integrated at a plurality of locations in the network.

Additional features and advantages of the invention will be set forth in the detailed description which follows, and in part will be readily apparent to those skilled in the art from the description or recognized by practicing the invention as described in the written description and claims hereof as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention, and together with the description serve to explain the principles and operation of the invention.

### BRIEF DESCRIPTION OF THE DRAWINGS

FIG. 1 is a spectral slice WDM transmitter according to the invention using reflection mode semiconductor amplifiers;

FIG. 2 is a spectral slice WDM transmitter according to the invention using transmission mode semiconductor amplifiers;

FIG. 3 shows the power transfer characteristic of a typical reflection mode semiconductor amplifier;

FIG. 4 shows a signal transfer characteristic through the amplifier of FIG. 3;

FIG. 5 shows signal amplitude waveforms and probability distributions for input power levels at both extremes of the curve shown in FIG. 3;

FIG. 6 shows the excess intensity noise standard deviation relative to the mean signal level for the amplifier of FIG. 3;

FIG. 7 shows input and output intensity distributions for the amplifier of FIG. 3; and

FIG. 8 shows a plot of root relative variance for a range of saturated power values.

### DETAILED DESCRIPTION OF THE INVENTION

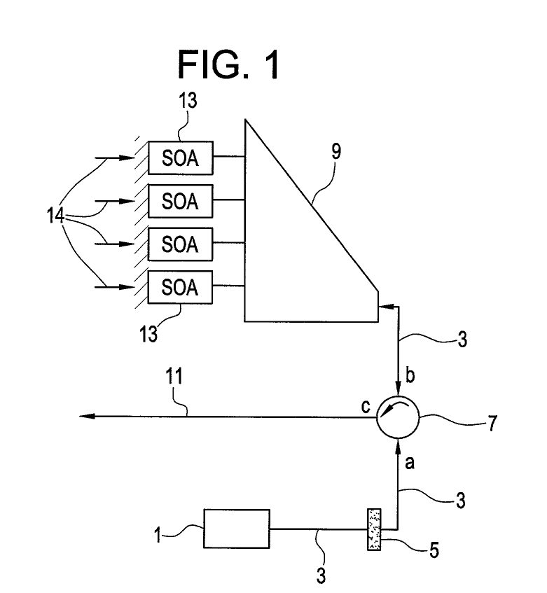

FIG. 1. shows a WDM transmitter comprising an erbium doped fiber amplifier 1 optically linked by a single fiber 3 via a free-spectral-range filter 5 and an optical circulator 7 to an arrayed waveguide grating 9. An output fiber 11 leads from a third terminal of the optical circulator 7. On the other side of the arrayed waveguide grating 9, an array of waveguides lead to respective reflection mode travelling wave semiconductor optical amplifiers 13. Each reflection mode travelling wave semiconductor optical amplifier 13 has opposite end facets, one of which is optically linked to its respective fiber and has very low reflectivity of around 10⁻⁵, and the other of which has a reflectivity of around 30%.

In operation, the erbium doped fiber amplifier 1 generates ASE to provide broad-band optical radiation along the single optical fiber 3. Filter 5 is a band pass filter which ensures that only light covering one free-spectral-range is transmitted on to the optical circulator 7 and arrayed waveguide grating 9. The arrayed waveguide grating 9 spectrally slices the ASE broad-band radiation and distributes the wavelength slices to the arrayed waveguides and the semiconductor optical amplifiers 13. Each of the amplifiers 13 is individually modulated by means of electrical signals 14 applied to its contacts. Each spectral slice passes through the amplifier and is reflected back through the amplifier to the fiber by the reflective facet. As it passes through the amplifier, the spectral slice is twice amplified and modulated so that the radiation reflected back to the arrayed waveguide is an optical version of the electrical signal applied to the amplifier having the same wavelength as the spectral slice. As each of the reflected optical signals has substantially the same wavelength distribution as the respective spectral slice distributed by the arrayed waveguide grating 9, they are all matched to the arrayed waveguide grating, which consequently efficiently multiplexes the signals back onto the single fiber 3. The multiplexed signals, now travelling in the opposite direction to the broad-band radiation from the erbium doped fiber amplifier 1, are separated from the broad-band radiation by the optical circulator 7 into the output fiber 11.

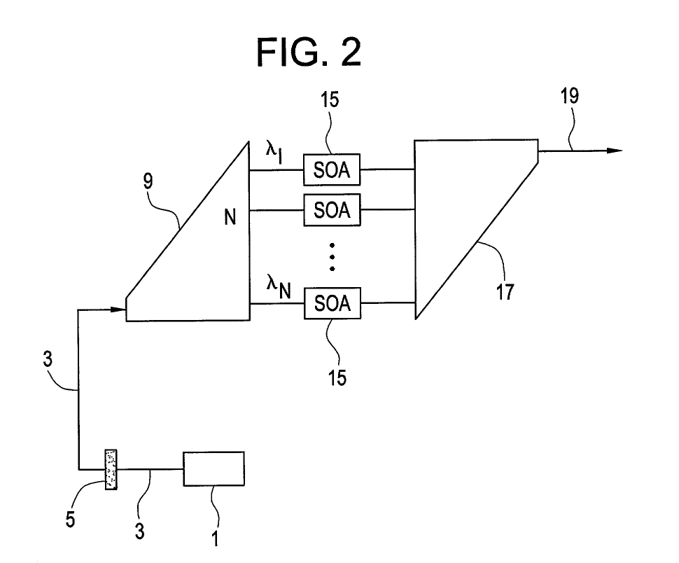

FIG. 2 shows an alternative WDM transmitter design to that of FIG. 1, and the same reference numerals have been used to denote corresponding components. Again an erbium doped fiber amplifier 1 is employed to provide broad-band optical radiation to a single fiber 3. The fiber 3 is optically linked via a free-spectral-range filter 5 to a first arrayed waveguide grating 9. On the other side of the first arrayed waveguide grating 9, an array of waveguides lead to first facets of respective transmission mode travelling wave semiconductor optical amplifiers 15. Each transmission mode travelling wave semiconductor optical amplifier 15 has opposite first and second facets with anti-reflective coatings. A further array of waveguides leads from the second facets of the semiconductor optical amplifiers to a second arrayed waveguide grating 17 identical to the first, having a single output fiber 19.

In operation, the broad-band optical radiation generated by the erbium doped fiber amplifier 1 is conducted along the single optical fiber 3. Filter 5 is a band pass filter which ensures that only light covering one free-spectral-range is transmitted to the arrayed waveguide grating 9. The arrayed waveguide grating 9 spectrally slices the ASE broad-band radiation and distributes the wavelength slices to the arrayed waveguides and the semiconductor optical amplifiers 15. Each of the amplifiers 15 is individually modulated by means of electrical signals applied to its contacts. Each spectral slice is therefore amplified and modulated as it passes through its respective amplifier so that the radiation transmitted into the second arrayed waveguide grating 17 is an optical version of the electrical signal applied to the amplifier having the same wavelength as the spectral slice. As each of the optical signals has substantially the same wavelength distribution as the respective spectral slice distributed by the first arrayed waveguide grating 9, they are equally matched to the second arrayed waveguide grating 17, which is identical to the first. The signals are therefore multiplexed by the second arrayed waveguide grating into the single output fiber 19.

The wavelength channels produced by the devices described are determined by the design of the arrayed waveguide grating 9 in terms of centre wavelength and pass-band shaping, and the excitation signal from the broad-band source as filtered by the free-spectral-range filter. The latter factor enables a number of identical transmitters to be selected for operation at different wavelengths simply by changing the free-spectral-range filter.

The output power of the travelling wave semiconductor optical amplifiers can be adjusted, in order to equalise their outputs and so minimise the overall signal dynamic range received, by use of a slow feedback control loop operating over a return channel transmitted back along the output fiber. This will help to minimise the effect of crosstalk resulting from wavelength division multiplexing.

WDM systems employing transmitters as described herein do not require expensive wavelength-selective sources, and the cost savings gained thereby make such systems particularly suitable for access networks, where users might not be willing to pay for expensive transmitters. However, by operating the travelling wave semiconductor optical amplifiers of the transmitters described above in the gain saturated regime, amplitude fluctuations in the spectral slices will be squeezed with the result that excess intensity noise will be reduced and the noise margin of the system will be increased. This effect enables the use of narrower spectral slices and hence fiber dispersion to be reduced. Furthermore, non-linear effects are reduced by use of narrow spectral slices from a broad-band incoherent source compared to alternative coherent sources. Such properties enable the systems described to be suitable for use in metropolitan networks where point to point spans may be of the order of several tens or even hundreds of kilometres.

The reflective amplifier provides three key benefits in spectrally sliced DWDM systems;

(i) It increases the available power in the slice to levels similar to those obtained from a semiconductor laser (˜1 mW);

(ii) Due to gain saturation induced amplitude squeezing, it reduces the amount of excess intensity noise (EIN) on the slice and therefore improves the noise margin of the system;

(iii) The reduced EIN allows narrower spectral slices to be used—hence improving the DWDM spectral efficiency and reducing the effect of fiber dispersion.

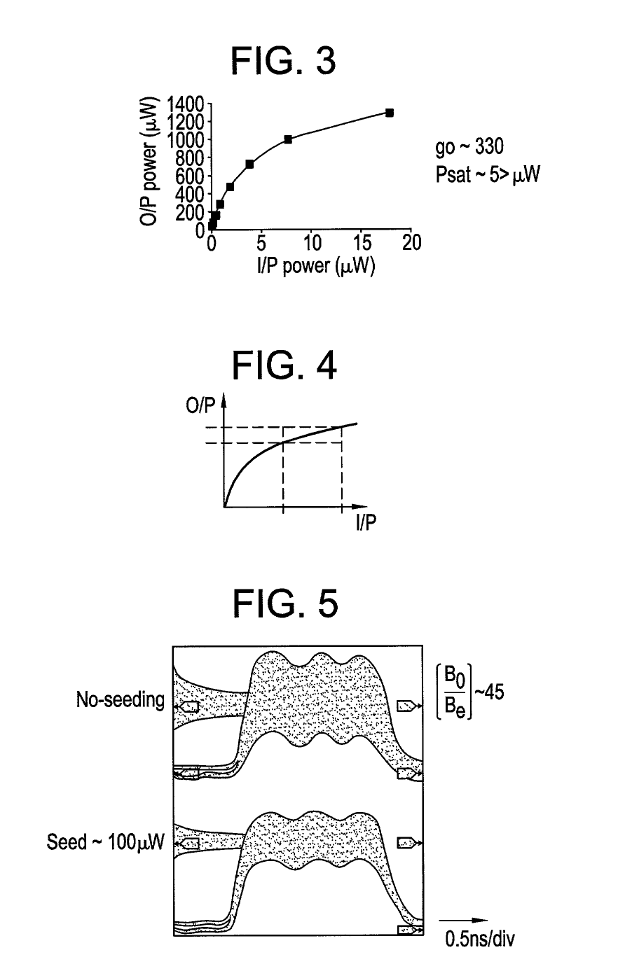

A typical reflective amplifier optical power transfer characteristic is shown in FIG. 3. This curve was measured with the SOA on-off keyed with a 2⁷-1 pseudo-random binary sequence at data rate of 1.25 Gbit/s. The net small signal gain is over 25 dB and the input saturation power (Pₛₐₜ) is ˜5 μW. The solid curve shows an empirical fit to the measured data points of the form:

Pₒᵤₜ—g(Pᵢₙ)=g₀PₛₐₜPᵢₙ/(Pₘ+Pₛₐₜ) (1)

where g₀ is the linear gain, and Pᵢₙ and Pₒᵤₜ are the SOA input and output powers respectively.

Using this as a basis, (see FIG. 4) one might expect that the degree of EIN squeezing obtainable at high input powers would be virtually unlimited. Indeed, using a simple transformation of random variables approach, it can be shown that the EIN noise variance of the amplified reflected light would scale roughly as:

[Pₛₐₜ/(Pᵢₙ+Pₛₐₜ)]² (when Pᵢₙ≧Pₛₐₜ) (2)

which becomes negligible when Pᵢₙ>>Pₛₐₜ.

However, this is not what is observed. Interestingly, it is found that the degree of amplitude squeezing obtained with a single SOA is insufficient to remove more than ˜60% of the EIN. FIG. 5 shows the relatively large residual EIN on a spectral slice from the above amplifier even when the input power was as high as 100 μW. FIG. 5 shows the signal amplitude waveforms and probability distributions for input power levels at both extremes of the curve shown in FIG. 3. The optical slice bandwidth B₀ was 69 GHz (0.55 nm) and the photo-receiver bandwidth Be was 1.55 GHz.

Measurements show that the EIN spectrum had a white-noise like, uniform power spectral density, over the bandwidth of the receiver.

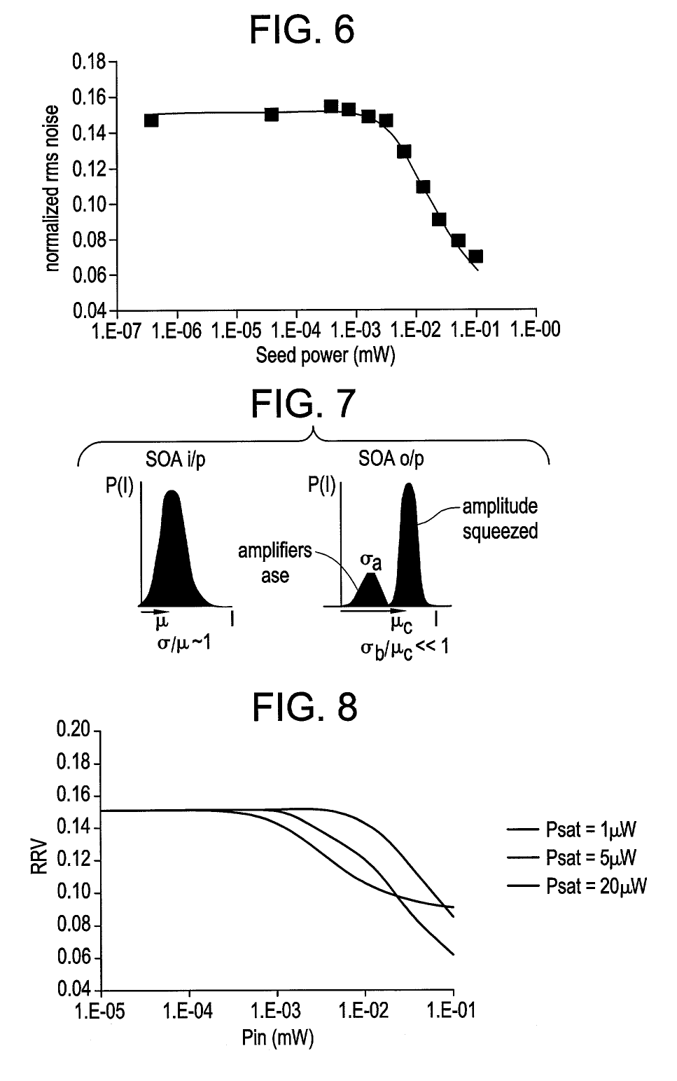

FIG. 6 shows the measured EIN standard deviation relative to the mean signal level as a function of seed power. The solid curve shows the theoretical fit derived below.

Beginning with the simple transformation of random variables approach (as tempted by the view shown in FIG. 4):

The following expression for the EIN standard deviation to mean ratio (or root relative variance RRV) of the receiver photocurrent (ignoring constant terms—without loss of generality wlog) can be formulated:

RRV=[Var{g(x)}]^{0.5}/E{g(x)}≈g′(x)σₘ/[g(x)+g″(x)σᵢₙ²/2]|_{x=μ} (3)

where, Var{.} and E{.} are the variance and expectation operators, g(x) is the measured reflective amplifiers optical power transfer characteristic given by equation (1), ′ and ″ indicate the first and second derivatives, and | means evaluate the result at x=μ=E{x}=Pᵢₙ in this case. For a polarised spectral slice, the input noise variance σᵢₙ²=Pᵢₙ².(Bₑ/Bₒ where (Bₑ/Bₒ) is the electrical to optical bandwidth ratio.

After further differentiation and algebra, we get the following expression for RRV:

RRV=[Pₛₐₜ/(Pᵢₙ+Pₛₐₜ)].(Bₑ/Bₒ)^{0.5} (when Pᵢₙ≧Pₛₐₜ) (4)

Equation (4) also assumes that (Bₑ/Bₒ)<<1 which is the case in practice.

This result (if it were the complete solution) would predict that the RRV could be made arbitrarily small simply by increasing Pᵢₙ. But, as we have seen, this is not the case. Nevertheless, this result will be used when deriving the complete expression in the following analysis.

Going back to first principles, consider the output of the reflective amplifier as the superposition of three electric fields:

(i) A parasitic amplified spontaneous emission a

(ii) The residual noise on the transformed input light b.

(iii) An ideal (noise-free) carrier produced by the amplitude squeezing process c where a, b and c are described by:

a=R_{e{a}(t).exp(jωₒt}; b=R_{e{b}(t).exp(jωₒt}; R_{e{c.exp}(jωₒt} (5)

and Re{.} means take the real part of the arguments. All carriers are at the same nominal optical carrier frequency ωₒ and have slowly-varying complex electric field amplitudes of a(t), b(t) and c respectively. (Note that a(t) and b(t) are normally distributed random processes with zero mean, whereas c is a constant.) The resulting intensity distributions are represented in FIG. 7.

At photo-detection we get i=k|a+b+c|² where k is a constant (set to unity wlog).

Thus,

$$\begin{matrix}i ( t ) = a ( t ) \cdot {a}^{*} ( t ) + b ( t ) \cdot {a}^{*} ( t ) + c \cdot {a}^{*} ( t ) + a ( t ) \cdot {b}^{*} ( t ) + b ( t ) \cdot {b}^{*} ( t ) + \\ c \cdot {b}^{*} ( t ) + a ( t ) \cdot {c}^{*} + b ( t ) {c}^{*} + {cc}^{*}\end{matrix} \qquad ( 6 )$$

where, * means the complex conjugate.

To simplify the nomenclature, assume that all variables are a function of t and drop the (t) symbol. It will also be useful later to write i, as defined by equation (6), in shorthand form as a row vector i.

Now, since E{a}=0; E{b}=0; and E{x,y}=0 (where x,y, εa,b,c s.t.x≠y); it is straightforward to show that the expected value of the photo-current reduces to:

E{i}=E{|a|²}+E{|b|²}+E{|c|²} (7)

The variance of the photocurrent Var{i} is given by E{i²}−E²{i} which we derive in stages below:

Using the vector notation introduced earlier,

E{i^{2}=E{i}^{T}.i} (8)

where T means vector transpose (i.e. a column-row vector product with time indices t and t′ respectively).

The vector product operation in equation (8) will result in a square 9×9 matrix (i.e., comprise 81 terms). Forming this matrix is a very lengthy and tedious process and is not re-produced here for reasons of brevity. Using standard statistical techniques, it can be shown that many of the terms in this matrix have an expected value of zero.

(Table 1 shows the locations of the non-zero terms):

TABLE 1

| | 1 | 2 | 3 | 4 | 5 | 6 | 7 | 8 | 9 |
|---|---|---|---|---|---|---|---|---|---|
| 1 | ✓ | | | | ✓ | | | | ✓ |
| 2 | | | | ✓ | | | | | |
| 3 | | | | | | | ✓ | | |
| 4 | | ✓ | | | | | | | |
| 5 | ✓ | | | | ✓ | | | | ✓ |
| 6 | | | | | | | | ✓ | |
| 7 | | | ✓ | | | | | | |
| 8 | | | | | | ✓ | | | |
| 9 | ✓ | | | | ✓ | | | | ✓ |

The table indices represent the location of the 9 terms in i equation (6). The non zero terms are collected below:

$$\begin{matrix}E \{ {i}^{2} \} = E \{ a ( t ) {a}^{*} ( t ) a ( {t}^{′} ) {a}^{*} ( {t}^{′} ) \} + E \{ b ( t ) {b}^{*} ( t ) b ( {t}^{′} ) {b}^{*} ( {t}^{′} ) \} + {\vert c \vert}^{4} + \\ 2 [ E \{ a ( t ) {a}^{*} ( t ) b ( {t}^{′} ) {b}^{*} ( {t}^{′} ) \} + E \{ b ( t ) {a}^{*} ( t ) a ( {t}^{′} ) {b}^{*} ( {t}^{′} ) \} ] + \\ 2 {\vert c \vert}^{2} [ E \{ a ( t ) {a}^{*} ( t ) \} + E \{ b ( t ) {b}^{*} ( t ) \} + \\ E \{ {a}^{*} ( t ) a ( {t}^{′} ) \} + E \{ {b}^{*} ( t ) b ( {t}^{′} ) \} ]\end{matrix} \qquad ( 9 )$$

Equation (9) can be simplified by using the following identity:

E{p.q.r.s}=E{p.q.}.E{r.s}+E{p.r}.E{q.s}+E{p.s}.E{q.r} (10)

provided, as in this case, p, q, r, and s, are zero mean normally distributed random variables. Under these conditions we also note that: E{e(t)e(t′)}=E{e*(t)e*(t′)}=0; and E{f.g}=0 f≈g. The following shorthand notation is also used: E{e(t)e*(t′)}=Rₑ(t,t′)=R ₑ(τ) is the autocorrelation function for the assumed stationary random process. (In the case of the noise measurements taken in the experiment this assumption is valid.)

Applying this identity and the other rules to equation (9) yields the following result:

$$\begin{matrix}E \{ {i}^{2} \} = {\vert a \vert}^{4} + {\vert b \vert}^{4} + {\vert c \vert}^{4} + {\vert {R}_{a} ( τ ) \vert}^{2} + {\vert {R}_{b} ( τ ) \vert}^{2} + \\ 2 [ {\vert a \vert}^{2} {\vert b \vert}^{2} + {R}_{a} ( τ ) {R}_{b} ( τ ) ] 2 {\vert c \vert}^{2} \cdot \\ [ {\vert a \vert}^{2} + {\vert b \vert}^{2} + {R}_{a} ( τ ) + {R}_{b} ( τ ) ]\end{matrix} \qquad ( 11 )$$

Now, from equation (7) we need to calculate E² {i}:

$$\begin{matrix}{E}^{2} \{ i \} = {\vert a \vert}^{4} + {\vert b \vert}^{4} + {\vert c \vert}^{4} + 2 {\vert a \vert}^{2} {\vert b \vert}^{2} + 2 {\vert c \vert}^{2} \cdot [ {\vert a \vert}^{2} + {\vert b \vert}^{2} ] \\ Thus , & ( 12 ) \\ \begin{matrix}Var \{ i \} = E \{ {i}^{2} \} - {E}^{2} \{ i \} \\ = {\vert {R}_{a} ( τ ) \vert}^{2} + {\vert {R}_{b} ( τ ) \vert}^{2} + 2 {R}_{a} ( τ ) {R}_{b} ( τ ) + \\ 2 {\vert c \vert}^{2} \cdot [ {R}_{a} ( τ ) + {R}_{b} ( τ ) ]\end{matrix} & ( 13 )\end{matrix}$$

Note, that in deriving equation (13) we have not taken account of the receiver filter. Since the filter output is simply i(t) * h(t) (where * now means convolution) and h(t) is the photo-receiver unit impulse response. It is straightforward to show that (13) becomes:

Var{i}={|Rₐ(τ)|²+|R_{b}(τ)|²+2 Rₐ(τ)R_{b}(τ)+2|c|².[Rₐ(τ)+R_{b}(τ)]} * h²(τ) (14)

In performing the above convolution and evaluating the result τ=0 we get the following final result for the variance in terms of system parameters:

Var{i}=[iₐ²+i_{b}²+2iₐi_{b}+2i_{c.}(iₐ+i_{b})].(Bₑ/Bₒ) (15)

where,

i_{a=P}ₐₛₑ;

i_{b}=[g′(μ) (94 ᵢₙ]² from equation (3) which can be solved to yield,

i_{b}=gₒPᵢₙ[Pₛₐₜ/(Pᵢₙ+Pₛₐₜ]²; and,

i_{c}=Pₒᵤₜ−i_{b} where Pₒᵤₜ=gₒPₛₐₜPᵢₙ/(Pᵢₙ+Pₛₐₜ) from equation (1).

Note, that the photo receiver responsivity (k) (which was set to unity), is unimportant as it would be eliminated when we form the RRV anyway, and the total photo-induced output Pₒᵤₜ=i_{c}+i_{b}

$$\begin{matrix}\begin{matrix}Var \{ i \} = \{ {P}_{ase}^{2} + {{( {g}_{o} {P}_{in} )}^{2} [ {P}_{sat} / ( {P}_{in} + {P}_{sat} ) ]}^{4} + \\ 2 {g}_{o} {P}_{in} {{P}_{ase} [ {P}_{sat} / ( {P}_{in} + {P}_{sat} ) ]}^{2} + \\ 2 [ {g}_{o} {P}_{sat} {P}_{in} / ( {P}_{in} + {P}_{sat} ) ] \cdot \\ [ 1 - {P}_{sat} / ( {P}_{in} + {P}_{sat} ) ] \cdot \\ [ {P}_{ase} + {g}_{o} {{P}_{in} [ {P}_{sat} / ( {P}_{in} + {P}_{sat} ) ]}^{2} ] \} ( {B}_{e} / {B}_{o} )\end{matrix} \\ Similarly , & ( 16 ) \\ E \{ i \} = {P}_{ase} + {g}_{o} {P}_{in} {P}_{sat} / ( {P}_{in} + {P}_{sat} ) & ( 17 )\end{matrix}$$

The curve in FIG. 6 shows a plot of RRV=[Var{i}]^{0.5}/E{i} using the following measured device parameters:

Pₐₛₑ=80 μW in the slice bandwidth Bo=69 GHz

Pₛₐₜ=5 μW

gₒ=330

Bₑ=1.55 GHz

Note that the above results assume that Pₐₛₑ is constant. In practice Pₐₛₑ will fall at high input powers (Pᵢₙ>>Pₛₐₜ), however, over the range plotted in FIG. 6 (and FIG. 8 below) this reduction is quite small (<2 dB) and is therefore omitted for simplicity.

FIG. 8 shows a plot of RRV for a range of Pₛₐₜ values. An analytical expression for the approximate behaviour of these curves at higher input powers can be estimated in order to find the limits on amplitude squeezing by making the following assumptions:

(i) At very high input power, Pᵢₙ>>Pₛₐₜ;

(ii) When (Pᵢₙ>>Pₛₐₜ), the cross term between 2i_{c}.(iₐ+i_{b}) in equation (15) dominates all other noise terms;

then,

E{i}≈Pₐₛₑ+gₒPₛₐₜ (Pᵢₙ>>Pₛₐₜ) (18)

Var{i}≈2gₒPₛₐₜPₐₛₑ(Bₑ/Bₒ) (P_{in>>P}ₛₐₜ) (19)

Hence, RRV|_{Limit} (Pᵢₙ>>Pₛₐₜ) becomes:

RRV|_{Limit} ≈[2gₒPₛₐₜPₐₛₑ(Bₑ/Bₒ)]^{0.5}/(Pₐₛₑ+gₒPₛₐₜ) (20)

≈[2Pₐₛₑ(Bₑ/BₒgₒPₛₐₜ]^{0.5} (Pₐₛₑ<<Pₛₐₜ) (21)

Equation 21 should be used only to give an indication of the maximum degree of squeezing obtainable and not to optimise SOA parameters. For example, RRV can be reduced by increasing Pₛₐₜ, but this is exactly the opposite of what we need to do in an Access network scenario where the input seeding power to the reflective SOA power will be low. As FIG. 8 shows, increasing Pₛₐₜ when the input power is low would reduce the degree of EIN squeezing.

The output ase power, Pₐₛₑ, is also important in determining the degree of squeezing. Pₐₛₑ will be reduced (but not eliminated) as the SOA is driven harder into gain saturation. Alternatively, Pₐₛₑ can also be reduced by reducing the optical slice width, but this will be at the expense of a reduced primary RRV=(Bₑ/Bₒ)^{0.5}. Nevertheless, where a narrow slice width (Bₒ) is being used, the spontaneous power Pₐₛₑ will be reduced, hence the amplitude squeezing effect will be more pronounced in higher density DWDM systems.

Hence, it can be seen that the amplitude squeezing of excess intensity noise by semiconductor optical amplifiers can be treated as a superposition of three fields: a parasitic noise field due to ase at the SOA output; a residual noise field due to imperfectly squeezed noise on the amplified spectral slice; and an idealised (EIN-free) carrier field created by the amplitude squeezing process. The beating between these three fields has been shown to accurately predict the noise variance observed at the SOA output.

It will be clear to persons skilled in the art that the erbium doped fiber amplifier employed in the embodiments shown in FIGS. 1 and 2 could be replaced by an appropriate alternative incoherent source, such as an LED, semiconductor optical amplifier or superluminescent diode to provide the required broad-band optical radiation. However, a super continuum source could also be used to provide the required broad-band optical radiation. A super continuum source provides a broad and smooth output of coherent optical radiation at multiple wavelengths, which produces less excess intensity noise than incoherent broad-band sources. However, a super continuum source is more complicated to implement.

If single polarisation semiconductor amplifiers are used, it is desireable that radiation from the broad-band source is depolarised in order to ensure that a proportion of the radiation from the source has the same polarity as the amplifier. The alternative would be to provide some form of polarity control, which would be complex and expensive to implement. For this purpose, where a single polarisation source is used, a depolariser (eg a Lyot depolariser) may be employed along the input fiber 3 between the broadband source 1 and the circulator 7 shown in FIG. 1 or anywhere along the fiber 3 as shown in FIG. 2.

Instead of an arrayed waveguide grating, the wavelength division multiplexer(s) could comprise a thin film filter, a directional coupler or a blazed grating type filter. The wavelength division multiplexer could be a discrete component or, if the optical signal generators are located at a plurality of locations in a network, then the wavelength division multiplexer could be integrated at various locations in the network; for example, the wavelength division multiplexer could comprise a single bandpass filter at each of a number of transmitter locations coupled to a single broad-band optical source. The arrayed waveguides coupling the travelling wave semiconductor optical amplifiers with the wavelength division multiplexer(s) could of course comprise fibers if these two components are remote from each other. Alternatively, for point to point optical transmission systems such as used in metropolitan area networks, each of the travelling wave semiconductor optical amplifiers and arrayed waveguide gratings could be co-located and integrated onto a single block of silicon.

The circulator 7 employed in the transmitter shown in FIG. 1 could be replaced by a directional coupler or other means known in the art.

It will be apparent to those skilled in the art that various modifications to the preferred embodiments of the invention as described herein can be made without departing from the spirit or scope of the invention as defined by the appended claims. Thus, it is intended that the present invention cover the modifications and variations of this invention provided they come within the scope of the appended claims and their equivalents.

What is claimed is:

1. An optical signal transmitter comprising:
(i) an optical source for generating broad-band optical radiation;
(ii) a wavelength division multiplexer optically linked to the optical source and operable to receive and slice spectrally the broad-band optical radiation; and
(iii) at least one optical signal generator optically linked to the wavelength division multiplexer to receive a spectral slice of the broad-band optical radiation;
wherein the optical signal generator comprises a travelling wave semiconductor optical amplifier, whereby the spectral slice of the broad-band optical radiation received by the semiconductor optical amplifier determines the wavelength of the signal generated by the semiconductor optical amplifier.

2. An optical signal transmitter according to claim 1, wherein the travelling wave semiconductor optical amplifier is operated in the gain saturated regime.

3. An optical signal transmitter according to claim 2, wherein the travelling wave semiconductor optical amplifier is a s ingle polarisation amplifier.

4. An optical signal transmitter according to claim 1, wherein the wavelength division multiplexer comprises an arrayed waveguide grating, a thin film filter, a directional coupler or a blazed grating type filter.

5. An optical signal transmitter according to claim 1, wherein the optical source comprises an erbium-doped fiber amplifier.

6. An optical signal transmitter according to claim 1, wherein the optical source comprises a semiconductor optical amplifier, a superluminescent diode, a super continuum source or an LED.

7. An optical signal transmitter according to claim 1, further comprising a bandpass filter to limit the spectrum of the broad-band optical radiation.

8. An optical signal transmitter according to claim 1, further comprising a depolariser optically linked to the broad-band source and the wavelength division multiplexer to depolarise optical radiation transmitted between the source and the wavelength division multiplexer.

9. An optical signal transmitter according to claim 1, wherein the semiconductor optical amplifier is a reflection-mode semiconductor optical amplifier and the transmitter further comprises an optical circulator or power splitter to separate the signal generated by the semiconductor optical amplifier from the broad-band optical radiation.

10. An optical signal transmitter according to claim 1, wherein the semiconductor optical amplifier is a transmission-mode semiconductor optical amplifier.

11. A wavelength division multiplexing source comprising an optical transmitter according to claim 9 incorporating at least two optical signal generators for receiving respective spectral slices of the broad-band optical radiation.

12. A wavelength division multiplexing source comprising an optical signal transmitter according to claim 10 incorporating at least two optical signal generators, and a further wavelength division multiplexer optically linked to the at least two optical signal generators and operable to multiplex the signals generated by the optical signal generators.

13. A network comprising a wavelength division multiplexing source according to claim 11, wherein the optical signal generators are located at a plurality of locations in the network and the wavelength division multiplexer(s) is/are integrated at a plurality of locations in the network.
